(19) United States
(12) Patent Application Publication
(10) Pub. No.: US 2018/0033114 A1
(43) Pub. Date: Feb. 1, 2018

(54) Graphics Pipeline That Supports Multiple Concurrent Processes

(71) Applicant: MediaTek Inc., Hsinchu (TW)

(72) Inventors: Chi-Ming Chen, Hsinchu (TW); Hsin-Hao Chung, Hsinchu (TW)

(21) Appl. No.: 15/219,509

(22) Filed: Jul. 26, 2016

(51) Int. Cl. G06T 1/20; G06T 15/00; G06T 15/80; G06F 9/54; G06T 1/60

(52) U.S. Cl. CPC G06T 1/20; G06F 9/544; G06T 1/60; G06T 15/80; G06T 15/005

(57) ABSTRACT

A Graphics Processing Unit (GPU) concurrently executes kernel codes programmed in more than one programming framework. The GPU includes a first command decoder that decodes a first set of commands issued by a first Application Programming Interface (API) for executing a first kernel code. The GPU also includes a second command decoder that decodes a second set of commands issued by a second API for executing a second kernel code. The GPU also includes a plurality of shader cores and a pipe manager. According to decoded commands, the pipe manager assigns a first set of shader cores and a second set of shader cores to concurrently execute the first kernel code and the second kernel code, respectively.

### TECHNICAL FIELD

Embodiments of the invention relate to the architecture of graphics processing systems.

### BACKGROUND

In computer graphics, rendering is a process of producing images on a display device from descriptions of graphical objects or models. A graphics processing unit (GPU) renders 2D and 3D graphical objects, which are often represented by a combination of primitives such as points, lines, polygons, and higher order surfaces, into picture elements (pixels). A GPU typically includes a rendering pipeline for performing rendering operations. A rendering pipeline includes the following main stages: (1) vertex processing, which processes and transforms the vertices (that describe the primitives) into a projection space, (2) rasterization, which converts each primitive into a set of pixels aligned with the pixel grid of the display with attributes such as position, color, normal and texture, (3) fragment processing, which processes each individual set of pixels, and (4) output processing, which combines the pixels of all primitives into a 2D display space.

A variety of programming frameworks have been developed for programming high performance software executed by GPUs. For example, OpenCL™ is an Application Program Interface (API) that supports massively-parallel code execution on cross-platform hardware, and OpenGL® (as well as its variants such as OpenGL for Embedded Systems (GLES)) is an API that supports 2D and 3D graphics rendering on cross-platform hardware. A graphics system often invokes these APIs at various stages of processing. For example, APIs that run on a central processing unit (CPU) can issue commands to direct a GPU to execute kernel code for image processing and frame composition. These APIs may include more than one API type; that is, they may be programmed in two or more programming frameworks such as in OpenGL and OpenCL. APIs of different API types issue command of different command types for executing kernel codes of different kernel code types. For example, OpenCL API issues OpenCL commands for executing OpenCL kernel code; and OpenGL API issues OpenGL commands for executing OpenGL kernel code. During kernel code execution, switching from one framework to another framework involve context switching. Frequent context switching can significantly reduce system performance with respect to frames per second (FPS) count. Therefore, there is a need to mitigate the performance impact caused by such context switching.

### SUMMARY

In one embodiment, a GPU is provided to concurrently execute kernel codes programmed in more than one programming framework. The GPU comprises: a first command decoder to decode a first set of commands issued by a first API for executing a first kernel code of a first programming framework; a second command decoder to decode a second set of commands issued by a second API for executing a second kernel code of a second programming framework; a plurality of shader cores; and a pipe manager coupled to the first command decoder, the second command decoder and the shader cores. According to decoded commands, the pipe manager is operative to assign a first set of shader cores and a second set of shader cores to concurrently execute the first kernel code and the second kernel code, respectively.

In another embodiment, a method is provided for concurrently executing kernel codes programmed in more than one programming framework. The method comprises: receiving commands from a driver module for executing a first kernel code of a first programming framework and a second kernel code of a second programming framework in a concurrent mode, wherein the commands include a first set of commands issued by a first API and a second set of commands issued by a second API; decoding the first set of commands with a first command decoder and the second set of commands with a second command decoder; and concurrently executing the first kernel code by a first set of shader cores and the second kernel code by a second set of shader cores according to decoded commands.

According to embodiments described herein, a GPU supports concurrent execution of processes that are coded in different types of programming frameworks. The concurrent execution provides high efficiency and reduces context switches such that the performance of a graphics system can be significantly improved.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a graphics system according to one embodiment.

FIG. 2 illustrates a GPU that supports the execution of two concurrent processes according to one embodiment.

FIG. 3 illustrates a timeline for execution a graphics application according to one embodiment.

FIG. 4 is a flow diagram illustrating a method for concurrently executing kernel codes of different programming frameworks according to one embodiment.

FIG. 5 is a flow diagram illustrating a method for exclusive mode execution according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention support concurrent execution of kernel codes that are programmed in more than one programming framework. The kernel codes programmed in different programming frameworks are referred herein as different types of kernel codes. Correspondingly, APIs programmed in different programming frameworks are referred herein as different types of APIs. In one embodiment, the concurrent execution is carried out by a GPU. The GPU may receive commands from a driver module for executing a first kernel code of a first programming framework and a second kernel code of a second programming framework. The commands may include a first set of commands issued by a first API and a second set of commands issued by a second API. The GPU may concurrently decode the commands with two command decoders. The GPU may assign a first set of shader cores to execute the first kernel code, and assign a second set of shader cores to execute the second kernel code. The numbers of the shader cores in the first set and in the second set may be determined according to the weighs provided by a driver module. The GPU then concurrently executes the first kernel code with the first set of shader cores and the second kernel code with the second set of shader cores according to the decoded commands.

In the following, systems and methods for supporting the concurrent execution of two types of kernel codes are described. As an example, OpenGL and OpenCL are described as the two programming frameworks for the kernel codes that may be concurrently executed. However, it should be understood that the systems and methods can be extended to concurrently execute more than two types of kernel codes. Moreover, it should be understood that the system and methods can support programming frameworks other than OpenGL and OpenCL.

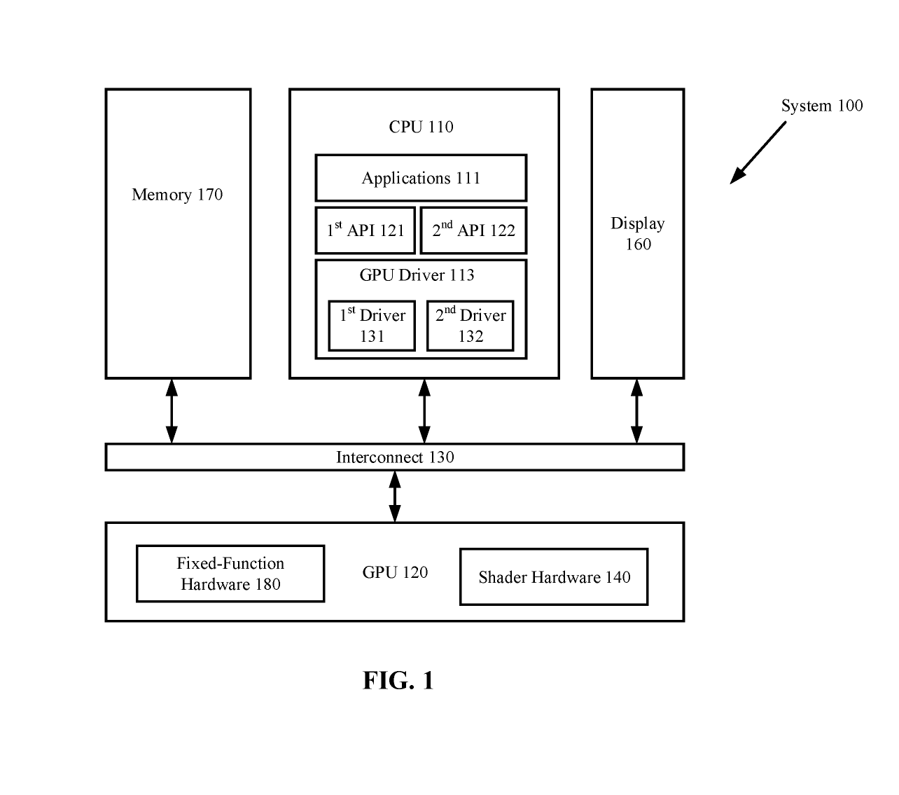

FIG. 1 illustrates a system 100 that includes a CPU 110 and a GPU 120 connected by an interconnect 130 according to one embodiment. Although only one CPU and one GPU are shown, it is understood that the system 100 may include any number of CPUs and GPUs, as well as any number of general-purpose and special-purpose processors. It is understood that many other system components are omitted herein for simplicity of illustration.

In one embodiment, the system 100 may be implemented as a system-on-a-chip (SoC). In one embodiment, the system 100 may be part of a mobile computing and/or communication device (e.g., a smartphone, a tablet, a laptop, etc.). In another embodiment, the system 100 may be part of server computer. Each CPU 110 may include multiple CPU cores and each GPU may include multiple GPU cores. In one embodiment, the CPU 110 and the GPU 120 communicate with a memory 170 (e.g., DRAM or other volatile or non-volatile random-access memory) via the interconnect 130.

In one embodiment, the CPU 110 may act as a host by sending commands to the GPU 120 for executing user applications; e.g., Advanced Driver Assistance Systems (ADAS), Deep Neural Network (DNN), and other applications. The commands may be issued from APIs to the GPU 120 via a driver module such as a GPU driver 113. The GPU driver 113 provides a low-level interface between the CPU software and GPU hardware. In one embodiment, a user application 111 may include software coded in more than one programming language. For example, the user application 111 may include parallel computing code in OpenCL and graphics rendering code in OpenGL, and the commands for executing different types of codes may be issued by corresponding types of APIs such as a first API 121 and the second API 122. In one embodiment, the different types of APIs also have corresponding types of drivers in the GPU driver 113, such as a first driver 131 and a second driver 132. According to the commands, the GPU 120 performs graphics operations and parallel computations to generate multiple image layers for a display 160. The generated image layers may include a user interface, a status bar, an image of graphical objects, among other elements. In one embodiment, the GPU 120 may composite the image layers into a frame for displaying on a display 160.

In one embodiment, the GPU 120 includes shader hardware 140 for performing parallel computations as well as graphics operations such as shading, including but not limited to vertex shading and fragment shading. One example of the shader hardware is a unified shader that can be programmed to perform the various shading operations. The shader hardware includes an array of shader cores, such as arithmetic logic units (ALUs), which execute instructions provided in shader programs referred to herein as kernel code. The kernel code can be written in high-level languages. For parallel computations, the kernel code may be written in OpenCL or other parallel programming languages; for graphics operations, the kernel code may be written in OpenGL Shading Language (GLSL), OpenGL for Embedded Systems (GLES), High-Level Shading Language (HLSL) in Direct3D, or C for Graphics (Cg), etc.

In one embodiment, the GPU 120 may utilize fixed-function hardware 180 to perform graphics operations. In one embodiment, the fixed-function hardware 180 may include hardware tailored for graphics operations. For example, The GPU 120 may perform 2D or 3D rendering operations using shader cores and the fixed-function hardware 180. The GPU 120 may also composite multiple image layers into frames for display by executing a compositor function implemented with the fixed-function hardware 180.

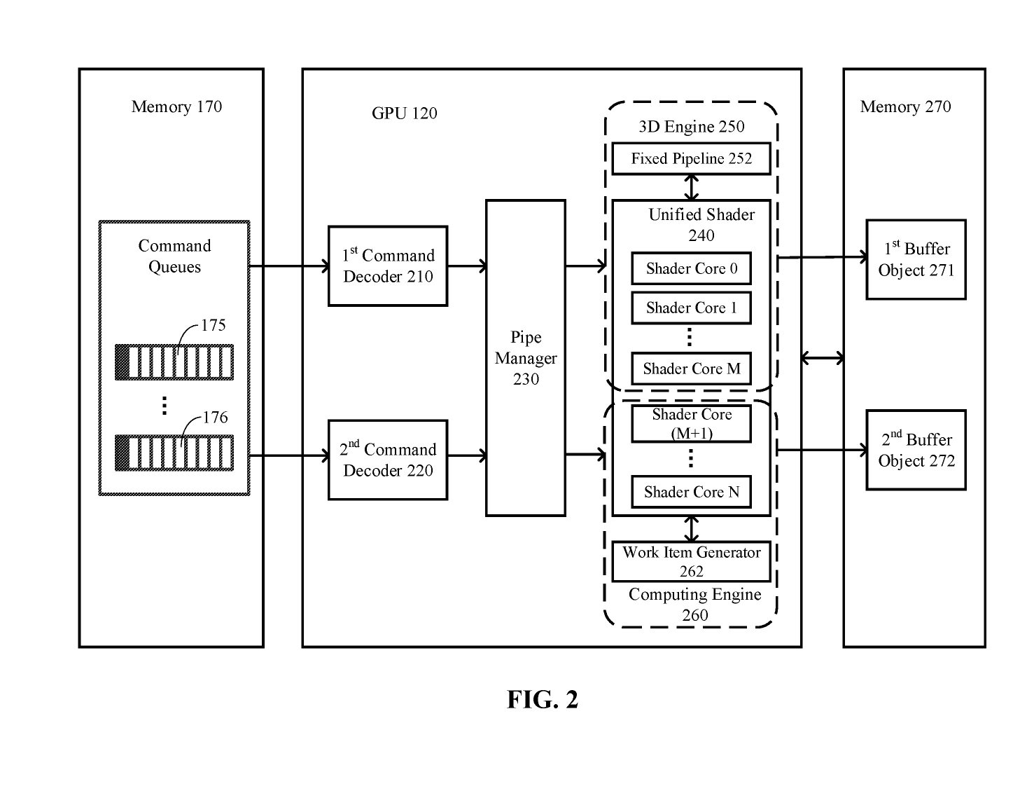

FIG. 2 illustrates further details of the GPU 120 according to one embodiment. The GPU 120 may operate in a number of execution modes, including but not limited to concurrent mode and exclusive mode. In the concurrent mode, the GPU 120 may concurrently execute two or more different types of kernel codes; while in the exclusive mode, the GPU 120 may execute only one type of kernel code. Each type of kernel code is executed according to a corresponding type of command. For example, the GPU 120 executes the OpenCL kernel code according to OpenCL commands, and executes the OpenGL kernel code according to OpenGL commands The embodiment of the GPU 120 in FIG. 2 is shown to include two command decoders 210 and 220 for decoding different types of commands (e.g., OpenGL/GLES and OpenCL); however, it is understood that the GPU 120 may include more than two command decoders for decoding more than two types of commands, with one command decoder for each corresponding type of commands.

In the embodiment of FIG. 2, the GPU 120 includes the first command decoder 210 to decode commands for executing a first kernel code (i.e., the kernel code of a first type). The GPU 120 also includes the second command decoder 220 to decode commands for executing a second kernel code (i.e., the kernel code of a second type). The first and the second command decoders 210, 220 may be implemented in hardware, firmware, software, or a combination of the above. The command decoders 210 and 220 receive commands from respective command queues 175 and 176 in the memory 170. The first command queue 175 stores the commands that are issued by the first API 121 via the first driver 131 to direct the GPU 120 to execute the first kernel code. The second command queue 176 stores the commands that are issued by the second API 122 via the second driver 132 to direct the GPU 120 to execute the second kernel code.

In one embodiment, the GPU 120 also includes a pipe manager 230 and a unified shader 240. The unified shader 240 is an example of the shader hardware 140 of FIG. 1. The unified shader 240, which includes an array of shader cores, is coupled to the pipe manager 230. The pipe manager 230 receives decoded commands from the first command decoder 210 and the second command decoder 220, and sends the decoded commands to the unified shader 240. The decoded commands may indicate whether the GPU driver 113 requests an operation to be executed in the concurrent mode or in the exclusive mode. If a requested operation indicates the concurrent mode of executing two types of kernel codes, the shader cores may be partitioned into two non-overlapping sets of shader cores: a first set of shader cores (“the first shader core set”) to execute the first kernel code, and a second set of shader cores (“the second shader core set”) to execute the second kernel code.

In one embodiment, the GPU driver 113 may send commands for concurrent mode execution of two kernel code types to the GPU 120, as well as the weights for the two command queues 175 and 176 (or equivalently, the weights for the two kernel code types). The weights may be used to calculate a first number of shader cores in the first shader core set and a second number of shader cores in the second shader core set. Thus, the GPU 120 may assign the first number of shader cores to execute the first kernel code and the second number of shader cores to execute the second kernel code, such that the first kernel code and the second kernel code can be executed concurrently. In one embodiment, the pipe manager 230 may perform the assignment of the shader cores according to the weights. In one embodiment, the GPU driver 113 (or more specifically, the first and second drivers 131 and 132) may determine the weights based on a number of factors including but not limited to: the required performance of executing the kernel codes and the workload incurred by executing the kernel codes.

In one embodiment, when both the first driver 131 and the second driver 132 request concurrent mode, the GPU driver 113 may choose a first weight (e.g., X) for the command queue 175 and a second weight (e.g., Y) for the second command queue 176. If there are a total of N shader cores in the unified shader 240, the number of shader cores in the first shader core set is

$$M = N \frac{X}{( X + Y )} ,$$

and the number of shader cores in the second shader core set is (N−M).

Alternatively, the GPU driver 113 may request the exclusive mode execution of a kernel code type. For example, the first driver 131 may request that all of the shader core be assigned to execute the first kernel code. The second driver 132 may also request that all of the shader core be assigned to execute the second kernel code. The requests for concurrent or exclusive mode may depend on considerations including but not limited to: the shader calculation power, bandwidth requirement of the kernel code, and system power consumption. If both the first driver 131 and the second driver 132 request exclusive mode execution, the pipe manager 230 may send decoded commands from the command queues 175 and 176 to the shader cores according to round-robin scheduling.

In one embodiment, the GPU 120 further includes a fixed pipeline 252 and a work item generator 262. The fixed pipeline 252 is an example of the fixed-function hardware 180 of FIG. 1. The fixed pipeline 252 and the first set of shader cores form a 3D engine 250 for executing the first kernel code to perform graphics rendering and image composition according to the corresponding decoded commands. The work item generator 262 generates work items, each of which is an independent element of execution. The work item generator 262 and the second set of shader cores form a computing engine 260 for executing the second kernel code to perform parallel computations according to the corresponding decoded commands. In an example where the second kernel code is OpenCL or other types of parallel computation code, the execution of the second kernel code is performed in parallel on the second set of shader cores as a set of work items.

In one embodiment, the output of the 3D engine 250 may include a first buffer object 271, and the output of the computing engine 260 may include a second buffer object 272. The first buffer object 271 and the second buffer object 272 may contain graphics data such as image layers. In one embodiment, the first buffer object 271 and the second buffer object 272 may be stored in a memory 270, such as a graphics memory or a portion of the system memory allocated to the GPU 120. The memory 170 and the memory 270 may be located on the same memory device or separate, different memory devices.

In one embodiment, each of the 3D engine 250 and the computing engine 260 maintains a program counter and the context of the kernel code being executed. Thus, the first kernel code and the second kernel code can executed concurrently without context switching.

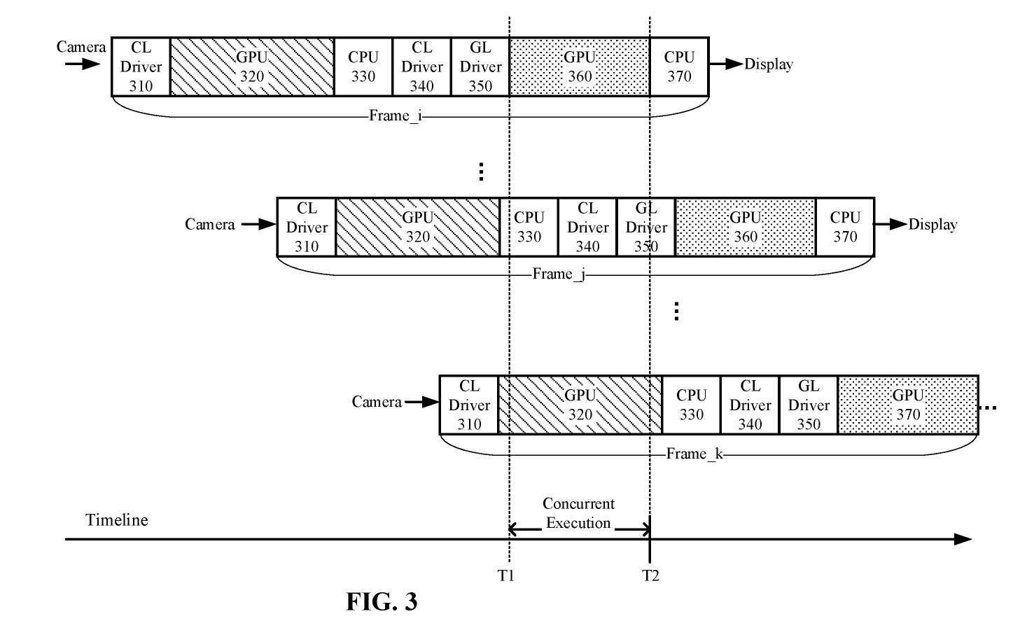

FIG. 3 illustrates an example of a timeline for executing a graphics user application, such as ADAS. For an ADAS application, there are two stages in the generation of a frame: during the first stage the GPU performs image processing based on the OpenCL specification, and during the second stage the GPU performs image composition based on the GLES specification. As the ADAS application is computationally intensive, reducing the amount of context switching in the GPU can significantly improve system performance. In one embodiment, the image processing portion (OpenCL, abbreviated as “CL”) of the application and the image composition portion (GLES, abbreviated as “GL”) of the application may be executed concurrently to reduce context switching.

The operations of FIG. 3 may be performed by a graphics system, such as the system 100 of FIG. 1 and the GPU 120 of FIGS. 1 and 2. Referring to FIG. 3, the operations for generating a frame include, but are not limited to, the following steps. First, the system receives image data from a source (e.g., a camera) (step 310). After receiving the image data, a CL driver invokes the GPU's computing engine 260 to perform parallel computations such as image processing (step 320). The CPU 110 is notified when the parallel computations complete (step 330), which in turns notifies the CL driver (step 340). The CL driver then notifies a GL driver (step 350), which invokes the GPU's 3D engine 250 to perform graphics operations including image composition (step 360). After the completion of image composition, the CPU 110 directs the output to be sent to a display (step 370).

As the steps 310-370 repeats for every frame, at certain point the GPU's 3D engine 250 (for the second stage operations) and the computing engine 260 (for the first stage operation) may be in operation at the same time. For example, the second stage of frame_i and the first stage of frame_k overlap in time (e.g., the time interval between T1 and T2). By setting both the OpenCL and OpenGL executions to the concurrent mode, the shader cores may be partitioned into two non-overlapping sets as mentioned above in connection with FIG. 2 to allow the first stage (step 320) and the second stage (step 360) GPU operations to be executed concurrently.

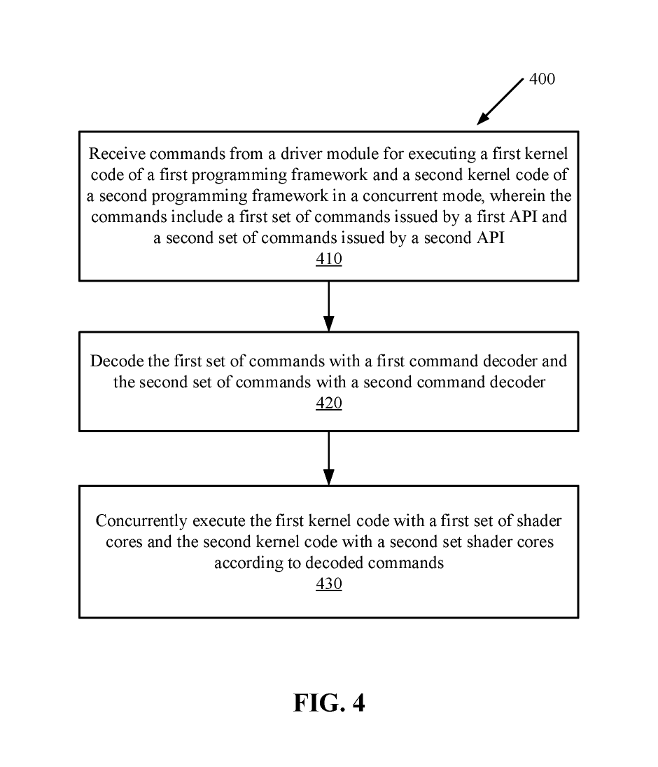

FIG. 4 illustrates a flow diagram of a method 400 performed by a GPU for executing different types of kernel codes in a concurrent mode according to one embodiment. That is, the GPU is operative to concurrently execute kernel codes programmed in more than one programming framework. In one embodiment, the method 400 may be performed by the GPU 120 of FIG. 1 and FIG. 2. The method 400 begins with the GPU receiving commands from a driver module for executing a first kernel code of a first programming framework and a second kernel code of a second programming framework in a concurrent mode (step 410). The commands include a first set of commands issued by a first API and a second set of commands issued by a second API; e.g., the first API 121 and the second API 122 of FIG. 1. The GPU decodes the first set of commands with a first command decoder and the second set of commands with a second command decoder (step 420). According to decoded commands, the GPU concurrently executes the first kernel code with a first set of shader cores and the second kernel code with a second set shader cores (step 430).

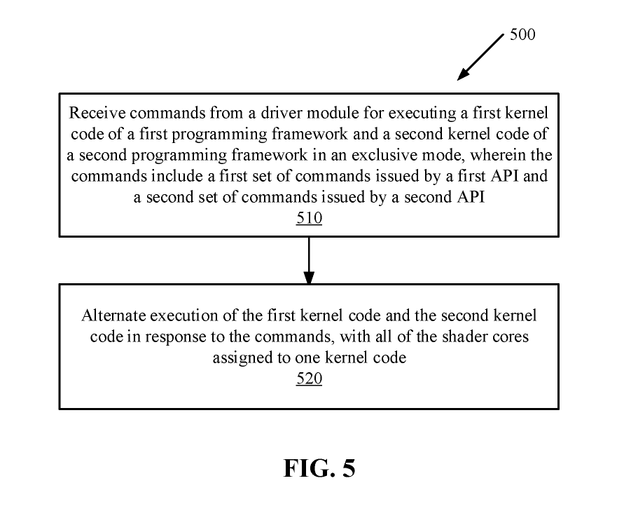

FIG. 5 illustrates a flow diagram of a method 500 performed by a GPU for executing different types of kernel codes in an exclusive mode according to one embodiment. In one embodiment, the method 500 may be performed by the GPU 120 of FIG. 1 and FIG. 2. The method 500 begins with the GPU receiving commands from a driver module for executing a first kernel code of a first programming framework and a second kernel code of a second programming framework in an exclusive mode (step 510). The commands include a first set of commands issued by a first API and a second set of commands issued by a second API; e.g., the first API 121 and the second API 122 of FIG. 1. In response to the commands, the GPU alternates execution of the first kernel code and the second kernel code, with all of the shader cores assigned to one kernel code; i.e., one of the first kernel code and the second kernel code (step 520). For example, if the first kernel code is to be executed first, the first command decoder decodes the first set of commands and the entire shader cores in the GPU execute the first kernel code according to the decoded commands. After the execution completes or a timer expires, the second command decoder decodes the second set of commands and the entire shader cores execute the second kernel code according to the decoded commands. Thus, the command decoding and kernel code execution may alternate between two different types of kernel codes. If there are more than two types of the kernel codes, the command decoding and kernel code execution may proceed in a round robin fashion.

Accordingly, the graphics system described herein supports both concurrent mode and exclusive mode execution for two or more types of kernel codes. As the concurrent execution of different types of kernel codes reduces context switching, the system performance can be improved.

The operations of the flow diagrams of FIGS. 5 and 6 have been described with reference to the exemplary embodiments of FIGS. 1 and 2. However, it should be understood that the operations of the flow diagrams of FIGS. 5 and 6 can be performed by embodiments of the invention other than those discussed with reference to FIGS. 1 and 2, and the embodiments discussed with reference to FIGS. 1 and 2 can perform operations different than those discussed with reference to the flow diagrams of FIGS. 5 and 6. While the flow diagrams of FIGS. 5 and 6 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A Graphics Processing Unit (GPU) operative to concurrently execute kernel codes programmed in more than one programming framework, the GPU comprising:
a first command decoder to decode a first set of commands issued by a first Application Programming Interface (API) for executing a first kernel code of a first programming framework;
a second command decoder to decode a second set of commands issued by a second API for executing a second kernel code of a second programming framework;
a plurality of shader cores; and
a pipe manager coupled to the first command decoder, the second command decoder and the shader cores, the pipe manager to assign a first set of shader cores and a second set of shader cores to concurrently execute the first kernel code and the second kernel code, respectively, according to decoded commands.

2. The GPU of claim 1, further comprising:
a fixed-function pipeline operative to execute the first kernel code with the first set of the shader cores according to the first set of commands decoded by the first command decoder.

3. The GPU of claim 2, wherein the fixed-function pipeline and the first set of the shader cores are operative to perform operations of 3D graphics rendering and image composition according to the first kernel code.

4. The GPU of claim 1, wherein the GPU further comprises a work item generator operative to generate work items from the second kernel code, the work items to be executed by the second set of the shader cores according to the second set of commands decoded by the second command decoder.

5. The GPU of claim 4, wherein the work item generator and the second set of the shader cores are operative to perform parallel computations according to the second kernel code.

6. The GPU of claim 1, wherein the first set and the second set of shader cores include a first number and a second number of shader cores, respectively, and the first number and the second number are calculated from weights provided by the driver module.

7. The GPU of claim 1, wherein the plurality of shader cores are further operative to alternate execution between the first kernel code and the second kernel code, with all of the shader cores assigned to one of the first kernel code and the second kernel code, in response to additional commands for executing the first kernel core and the second kernel core in an exclusive mode.

8. The GPU of claim 1, wherein the first command decoder is operative to receive the first set of commands from a first command queue in a memory, and the second command decoder is operative to receive the second set of commands from a second command queue in the memory.

9. The GPU of claim 1, wherein the first command decoder is operative to decode Open Graphics Library (OpenGL) code and the second command decoder is operative to decode Open Computing Language (OpenCL) code.

10. The GPU of claim 1, wherein the first API is an OpenGL API and the second API is an OpenCL API.

11. A method performed by a Graphics Processing Unit (GPU) for concurrently executing kernel codes programmed in more than one programming framework, the method comprising:
receiving commands from a driver module for executing a first kernel code of a first programming framework and a second kernel code of a second programming framework in a concurrent mode, wherein the commands include a first set of commands issued by a first Application Programming Interface (API) and a second set of commands issued by a second API;
decoding the first set of commands with a first command decoder and the second set of commands with a second command decoder; and
concurrently executing the first kernel code by a first set of shader cores and the second kernel code by a second set of shader cores according to decoded commands.

12. The method of claim 11, further comprising:
executing the first kernel code by the first set of the shader cores and a fixed-function pipeline according to the first set of commands decoded by the first command decoder.

13. The method of claim 12, wherein executing the first kernel code further comprises:
performing operations of 3D graphics rendering and image composition according to the first kernel code.

14. The method of claim 11, further comprising:
executing the second kernel code as work items by the second set of the shader cores according to the second set of commands decoded by the second command decoder.

15. The method of claim 14, wherein executing the second kernel code further comprises:
performing parallel computations according to the second kernel code.

16. The method of claim 11, wherein the first set and the second set of shader cores include a first number and a second number of shader cores, respectively, the method further comprises:
calculating the first number and the second number from weights provided by the driver module.

17. The method of claim 11, further comprising:
alternating execution between the first kernel code and the second kernel code, with all of the shader cores assigned to one of the first kernel code and the second kernel code, in response to additional commands for executing the first kernel core and the second kernel core in an exclusive mode.

18. The method of claim 11, further comprising:
receiving, by the first command decoder, the first set of commands from a first command queue in a memory; and
receiving, by the second command decoder, the second set of commands from a second command queue in the memory.

19. The method of claim 11, wherein decoding the first set of commands and the second set of commands further comprises:
decoding, by the first command decoder, Open Graphics Library (OpenGL) code; and
decoding, by the second command decoder, Open Computing Language (OpenCL) code.

20. The method of claim 11, wherein the first API is an OpenGL API and the second API is an OpenCL API.
